(19) United States
(12) Patent Application Publication
(10) Pub. No.: US 2003/0161906 A1
(43) Pub. Date: Aug. 28, 2003

(54) Utility machine with portable control device

(76) Inventors: Klaus Braunhardt, Zweibrucken (DE); Lutz Bischoff, Dellfeld (DE); Folker Beck, Bettendorf, IA (US); Britta Stankewitz, Pforzheim (DE); Peter Ehinger, Ditzingen (DE)

Correspondence Address: Kevin J. Moriarty, c/o Deere & Company, One John Deere Place, Moline, IL, 61265-8098, US

(21) Appl. No.: 10/353,182

(22) Filed: Jan. 27, 2003

(30) Foreign Application Priority Data
Jan. 30, 2002 (DE) 102 03 653.5

(51) Int. Cl. B29B 13/00

(52) U.S. Cl. 425/135

(57) ABSTRACT

A utility machine having an actuator and a portable control device. The portable control device exchanges data with the actuator over a wireless data transmission arrangement and is equipped with an input arrangement and an output arrangement. The actuator can be influenced by the input arrangement of the control device. A sensor for measuring an operating parameter of the utility machine influenced by the actuator generates a measured value that can be transmitted over the wireless data transmission arrangement to the control device. The output arrangement can be operated to display an information that depends on the measured value of the sensor. Thereby the operator can carry on an interactive dialog with the utility machine over the control device.

### FIELD OF THE INVENTION

The present invention is directed to a utility machine with at least one actuator and a portable control device that is arranged to exchange data over a wireless data transmission arrangement with the actuator and is equipped with an input arrangement and an output arrangement where the actuator can be influenced by the input arrangement of the control device.

### BACKGROUND OF THE INVENTION

EP 1 004 230 A describes a portable control device for an agricultural vehicle. The portable control device that can be held in one hand permits an operator to stand at a distance from the vehicle control at least one function of the vehicle or an operating implement connected to it. Thereby processes that are normally controlled from the operator's cab of the vehicle, but are difficult to follow visually, such as the adjustment of a hydraulic power lift, can be performed more easily. In normal operation the control device can be coupled to a docking station in the operator's cab of the vehicle. It may also be equipped with a display arrangement. The data displayed are not specified in any further detail. A remote control arrangement would also be desirable for electrically controlled cleaning sieves on a combine.

GB 2 263 376 A describes a vehicle monitoring system that permits the transmission of operating parameters of a vehicle over a wireless telephone connection to a central monitoring station.

### SUMMARY OF THE INVENTION

It is an object of the present invention to provide a utility machine having a control device that simplifies the diagnosis of the condition of the utility machine for the operator and a possible recognition of defects.

The portable control device is equipped with an input arrangement and an output arrangement and can be carried along by an operator when he performs a walk around the utility machine for purposes of maintenance or diagnosis and inspects the machine. The control device communicates over a bi-directional, wireless connection with at least one actuator of the utility machine. For this purpose a radio or an infrared transmission may be provided. The operator can affect one or more operating parameters of the utility machine by inputs into the input arrangement of the control device for purposes of control. Within the scope of the present invention the term utility machine should be understood to cover not only a particularly agricultural vehicle, such as, for example, a self-propelled harvesting machine, but also implements connected to the vehicle, for example, attached or coupled implements. It is proposed that the output arrangement that operates, for example, optically or acoustically be arranged to reproduce information that is a function of the measured value of a sensor, which detects an operating parameter that can be affected by the actuator, and whose measured values or data derived there from are transmitted to the control device over the bidirectional data transmission arrangement. Thereby the operator can carry on an interactive dialog with the utility machine over the control device.

In this way the operator is given the possibility of moving into the vicinity of the actuator or the element of the utility machine affected by it and to change an operating parameter of the utility machine that is in operation by an input into the control device and to have a measured result of the change in the operating parameter provided as an output on the output arrangement of the control device. Thereby from this location an optical and/or acoustic control of the utility machine by the operator becomes possible and in addition the output of the measured result of the sensor, or information derived there from, becomes possible.

The output arrangement can provide measured values of the sensor and preferably associated allowable upper and/or lower limit values as output which have been stored in memory. Thereby the operator can easily recognize whether the utility machine is capable of operating successfully or that maintenance or repair operations are required.

It is also possible to categorize the measured values in various classes, such as “in order” or “faulty” and a display of the class associated with each particular measured value of the sensor, in order to simplify the judgment of the measured values further for the operator.

In a more advanced embodiment the output arrangement provides suggestions for action. It can, for example, call the operator's attention to the need for the replacement of a defective component if the measured values of the sensor point to a defect in the particular component. For this purpose a form of data bank may be provided in which possible measured values and the associated information are stored in memory. The actual measured values are then compared with the possible measurement values and for those values with the best fit the associated information is displayed.

Preferably a test run of the actuator can be performed with the input arrangement of the control device. In this test run the actuator runs through differing pre-programmed positions, so that the utility machine operates in several operating parameters. Appropriately the control device provides an instruction to the operator which test run is being performed at a given time.

In a preferred embodiment the test programs that can be called up at a given time can be a function of the physical position of the control device. An appropriate position detection arrangement can be used to determine at which location of the utility machine the control device is located at that time. From at least two available test runs a corresponding software selects only that one test run that can be followed well optically or acoustically by the operator from the position of the control device at that time. Only these test runs can be selected by means of the input arrangement. For this purpose corresponding menus or menu points may be provided that can be activated and deactivated as a function of the position.

After the conclusion of the test run the output arrangement provides an advice as to the result of the test run to the operator. Information as to the result is derived from the collected measurement values of the sensor or the sensors that, as a rule, includes several classes which is provided as an output.

### BRIEF DESCRIPTION OF THE DRAWINGS

FIG. 1 is a semi-schematic side view of an agricultural combine.

FIG. 2 is a schematic view of the on-board computer system of the combine.

FIG. 3 shows a schematic view of the control device of the combine.

### DETAILED DESCRIPTION

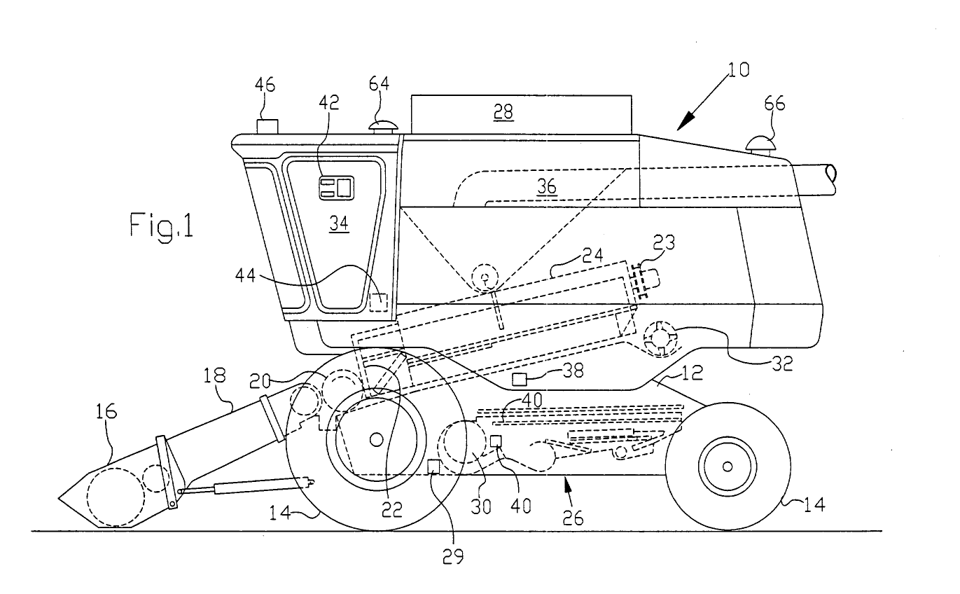

FIG. 1 illustrates a self-propelled agricultural combine 10. Although the invention is disclosed on an axially aligned rotary combine, it can also be applied to conventional combines and other combines, as well as, to any other type of utility or agricultural machine.

The combine 10 includes a support structure 12 having wheels 14. A harvesting platform 16 extends forward from the combine 10 and conducts harvested crop to a feeder house 18. The feeder house 18 contains a conveyor arrangement in order to conduct the harvested crop to the threshing, separating and cleaning assemblies of the combine 10. The feeder house 18 conducts the harvested crop to an inlet beater 20 extending in the transverse direction which conducts the crop through an inlet transition section 22 to an axial threshing and separating assembly 24. Grain and chaff are conducted by the axial threshing and separating assembly 24 to a cleaning assembly 26. The cleaning assembly 26 directs the cleaned grain to an elevator which lifts the clean grain to a grain tank 28. Chaff is blown out the rear of the combine 10 by a cleaning fan 30. Harvested crop material that is neither grain nor chaff is conducted by the axial threshing and separating assembly 24 to an outlet beater 32 arranged in the transverse direction which conveys this material out of the rear of the combine 10. Cleaned grain stored temporarily in the grain tank 28 can be discharged by the actuation of a discharge auger 36 controlled by the operator in an operator's cab 34.

An on-board computer 44 is located at the rear of the operator's cab 34. It is used for the adjustment of the various actuators of the combine 10.

A first actuator is used for the adjustment of an adjustable drive 23 of the threshing and separating assembly 24. An internal combustion engine, that is used as the main engine of the combine 10, also drives the adjustable drive 23. The adjustable drive 23 is a belt drive that is driven by a variable diameter belt drive pulley, not shown, and a variable diameter belt driven pulley and is drivingly coupled to the rear side of the threshing and separating assembly 24. A belt extends between the driving belt pulley and the driven belt pulley. Hydraulic cylinders control the diameters of the belt pulleys. A first hydraulic cylinder is coupled to the driven belt pulley and moves the end faces of the belt drive pulley inward or outward, in order to control the effective diameter of the belt drive pulley relative to the belt. By changing the effective diameter of the belt pulleys the effective velocity of the driven belt pulley is changed. The hydraulic cylinder is supplied over a hydraulic line with pressurized hydraulic fluid from a valve assembly 35. The valve assembly 35 is controlled electrically by the on-board computer 44. Thereby the hydraulic cylinders operate as actuators for the adjustment of the rotational speed of the threshing and separating assembly 24. The rotor is driven by the belt drive pulleys with variable diameter at a constant, selected rotor velocity.

A second actuator is an electric motor 29 that drives the cleaning fan 30. The rotational speed of the electric motor 29 is controlled by the on-board computer 44.

The on-board computer 44 is connected with a first sensor 38 in the form of a rotational speed sensor, that detects the rotational speed of the rotor of the threshing and separating assembly 24. A second sensor 40 that is also connected with the on-board computer 44 is arranged ahead of the air outlet of the cleaning fan 30 and detects the velocity of the air issuing from the cleaning fan 30.

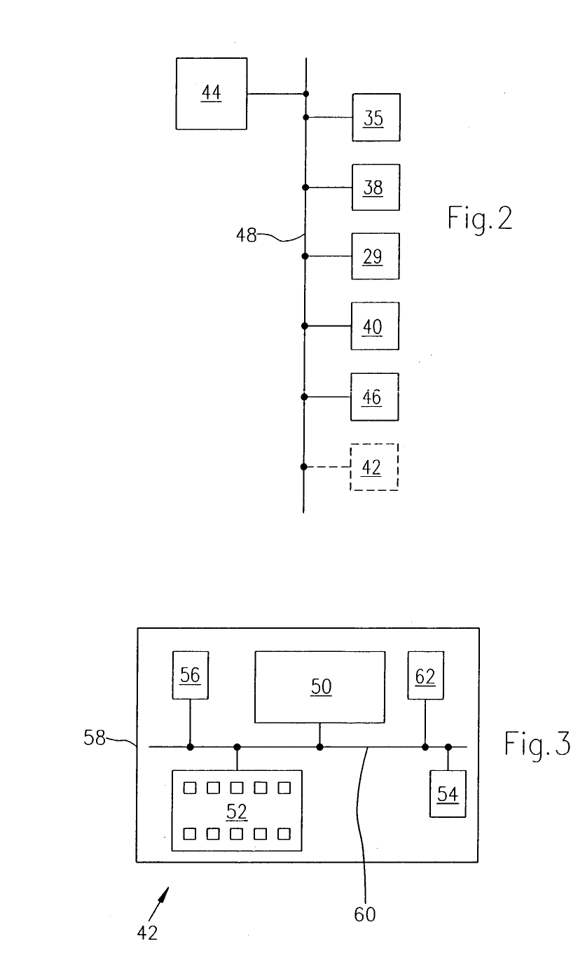

Furthermore the on-board computer 44 is connected with a data transmission arrangement 46, that is arranged for the transmission and reception of data. As shown in FIG. 2, the on-board computer 44 is connected over a bus 48 with the first sensor 38, the second sensor 40, the electric motor 29 of the cleaning fan 30, the valve assembly 35 of the variable drive 23 of the threshing and separating assembly 24 and the data transmission arrangement 46.

A control device 42 is shown in greater detail in FIG. 3. The control device 42 is provided with a control arrangement 54 that is connected over a bus 60 with a display arrangement 50 used as output arrangement, a keyboard 52 used as input arrangement and a bi-directional data transmission arrangement 56. The aforementioned components of the control device are arranged in a housing 58 along with an appropriate power supply.

In normal operation of the combine 10 the control device 42 can be fastened in the operator's cab 34 to a corresponding docking station and used for the input and display of operating parameters of the combine 10, as shown in FIG. 1. In normal operation when the control device 42 is docked in the operator's station 34 it is connected to the bus 48, as is indicated by the dashed lines in FIG. 2. When the control device is connected to the bus 48, there is the possibility of charging memory elements of the power supply of the control device 42 from the on-board network of the combine 10.

By corresponding inputs into the keyboard 56 the operating values selected from determined input possibilities of the actuators can be provided as input. Thereby corresponding data is transmitted by the control arrangement 54 of the control device 42 to the on-board computer 44. A manual change of previously provided operating values by means of the keyboard 54 is also conceivable. The display arrangement 50 is used for the display of the selected operating values and/or the operating values that can be selected and of measured values of the sensors or information derived there from. The data displayed or data on which these are based are transmitted by the on-board computer 44 to the control arrangement 54. It should be noted that it is conceivable that the functions of the on-board computer 44 can be transferred to the control arrangement 54 of the control device 42. In that case the on-board computer 44 could be eliminated and the control arrangement 54 would interact directly with the actuators and sensors, if necessary, over the data transmission arrangement 46 and 56.

In order to scrutinize the performance of the combine after the end of the operation or upon a maintenance operation the control device 42 can be separated from the docking station arranged in the operator's cab 34. The on-board computer 44 is connected with the control arrangement 54 of the control device 42 over the data transmission arrangements 46 and 56 that communicate with each other by means of electromagnetic radio frequency or (infra-red) light wave radiation. The control device 42 makes it possible for the operator to walk around the combine 10 and to inspect the individual operating elements of the combine 10—if necessary, after opening access doors—and to control the actuators associated with the operating element by means of the keyboard 52. In addition the display arrangement 50 displays the measurement values of sensors that are associated with the operating elements. Thereby the portable, removable control device 42 makes possible a change of an operating parameter controlled by the operator and a simultaneous output of the measured values of the sensors 38 and 40 on the display arrangement 50 and an optical and acoustic control of the operating elements by the operator.

If the operator is located, for example, in the vicinity of the cleaning fan 30, he can bring about a test run of the cleaning fan 30 by an input into the keyboard 52. The control arrangement 54 induces the on-board computer 44 to have the electric motor 29 run through a certain range of rotational speeds. The sensor 40 detects the air flow velocity of the air flow issuing from the cleaning fan. In connection with information stored in the on-board computer 44 regarding the immediate target rotational speed of the electric motor 29, during the entire test run a data collection is accumulated step by step, in which the rotational speeds of the electric motor 29 and the air flow velocities are stored in memory. Simultaneously the operator controls the cleaning fan optically and acoustically. After the end of the test run a comparison of the data collected with data stored in memory is performed. If the data collected corresponds to target values stored in memory the display arrangements shows that the test run was performed with a positive result, otherwise repair recommendations are displayed.

Analogously the operator, who is now located in the vicinity of the threshing and separating assembly 24, can bring about a test run of the threshing and separating assembly 24 over the keyboard 52. Then the on-board computer 44 induces, over the adjustable drive 23, the rotor of the threshing and separating assembly 24 to be driven successively at various rotational speeds. The target rotational speeds are gradually stored in memory along with the measured values of the sensor 38 that detects the actual rotational speed of the rotor of the threshing and separating assembly 24. Simultaneously the operator controls the threshing and separating assembly optically and acoustically. Following this a comparison of the measured data with data stored in memory is performed. If no obvious differences are found so that it can be concluded that the adjustable drive 23 operates properly the display arrangement indicates a successful conclusion of the test run; otherwise repair recommendations can be displayed.

In order to simplify the work of the operator, the control device is equipped with a position detecting arrangement 62. The latter may be a GPS receiver. Arrangement 62 permits the control arrangement 54 to determine the location of the control device 42 relative to the combine 10 and the position of the combine itself which is provided with two GPS receivers 64 and 66. Position data are transmitted over the data transmission arrangement 46 and 56 to the control device 42. A menu shown on the display arrangement 50 offers at any one time only test runs that can be well observed from the physical location at which the control device 42 is located. In case that the operator nevertheless desires a certain test run, although he is not located at an appropriate position, an input of the desired test run can be initiated equally well by a corresponding input of the desired test run that circumvents the limitation on the selection.

Having described the illustrated embodiment, it will become apparent that various modifications can be made without departing from the scope of the invention as defined in the accompanying claims.

1. A utility machine with at least one actuator and one portable control device that is arranged for exchanging data with the actuator over a wireless data transmission arrangement, the portable control device is equipped with an input arrangement and an output arrangement, the actuator can be influenced by the input arrangement of the control device, whereby a sensor is arranged for measuring an operating parameter of the utility machine that can be influenced by the actuator and generating a measured value, the measured value can be transmitted over the wireless data transmission arrangement to the control device, and the output arrangement can be operated to illustrate an output that depends on the measured value of the sensor.

2. A utility machine as defined by claim 1 wherein the output arrangement can be operated to output the measured value of the sensor and at least one allowable limit value that is stored in memory.

3. A utility machine as defined by claim 2 wherein the output arrangement can be further operated to output information associated with the measured value of the sensor.

4. A utility machine as defined by claim 1 wherein the output arrangement can be further operated to output information associated with the measured value of the sensor.

5. A utility machine as defined by claim 3 wherein the information displayed by the output arrangement derived from the measured value of the sensor includes a recommendation for action.

6. A utility machine as defined by claim 4 wherein the information displayed by the output arrangement derived from the measured value of the sensor includes a recommendation for action.

7. A utility machine as defined by claim 1 wherein the input arrangement can be operated to influence a test run of the actuator, in which the actuator actuates various operating parameters of the utility machine.

8. A utility machine as defined by claim 3 wherein the input arrangement can be operated to influence a test run of the actuator, in which the actuator actuates various operating parameters of the utility machine.

9. A utility machine as defined by claim 8 wherein the output arrangement displays the recommendation for action directed to the test run of the actuator currently being performed.

10. A utility machine as defined by claim 9 wherein the test run can be recalled from memory depending on the physical position of the control device.

11. A utility machine as defined by claim 10 wherein the output arrangement that can be operated to provide an output as a result of the test run derived from measured values of the sensor.
